(19) United States
(12) Patent Application Publication
(10) Pub. No.: US 2023/0359020 A1
(43) Pub. Date: Nov. 9, 2023

(54) DEFLECTION DEVICE FOR LISSAJOUS SCANNING

(71) Applicants: HUAWEI TECHNOLOGIES CO., LTD., Shenzhen (CN); FRAUNHOFER GESELLSCHAFT ZUR FOERDERUNG DER ANGEWANDTEN FORSCHUNG E.V., Muenchen (DE)

(72) Inventors: Ulrich HOFMANN, Itzehoe (DE); Fabian SCHWARZ, Itzehoe (DE); Oleg PETRAK, Itzehoe (DE); Aloshious Thottappattu JOY, Itzehoe (DE); Shanshan GU-STOPPEL, Itzehoe (DE); Frank SENGER, Itzehoe (DE); Frerk SOERENSEN, Itzehoe (DE); Yong CAO, Munich (DE)

(21) Appl. No.: 18/316,733

(22) Filed: May 12, 2023

Related U.S. Application Data
(63) Continuation of application No. PCT/EP2020/082093, filed on Nov. 13, 2020.

(51) Int. Cl. G02B 26/08; G02B 26/10

(52) U.S. Cl. CPC G02B 26/0858; G02B 26/101

(57) ABSTRACT

A deflection device for Lissajous scanning is provided. The deflection device includes a frame and a mirror. The mirror is movably arranged in a recess in the frame by means of a suspension mount including one or more springs. The mirror may be configured to swing back and forth about each of two or three axes with a respective eigenfrequency for reflecting incoming light at different angles to form a two-dimensional Lissajous pattern. The deflection device may include a driving device configured to excite swing motion of the mirror about each of the two or three axes at or near the respective eigenfrequency. Each of the one or more springs has a shape of a path segment along a circumference of the mirror together covering more than 360 degrees. An arrangement of the one or more springs provides a compact suspension for the mirror and larger tilt angles.

### TECHNICAL FIELD

The present application relates to the field of optical communication, and more particularly to a deflection device for a Micro-Electrical-Mechanical-System (MEMS) scanner with Lissajous scanning.

### BACKGROUND

In the optical regime, MEMS (Micro-Electrical-Mechanical-System) technology has been an enabling tool for numerous cutting-edge devices for optical communication. A MEMS scanner, which is capable of two-dimensional optical scanning, plays a vital role in various low-power and compact scanning applications, including projection, sensing, and imaging. Lissajous scanning is of great interest for compact laser projectors, as micromirrors used in such scanning oscillate resonantly in two axes to achieve much larger amplitudes than non-resonantly operated scanners. With respect to scanned laser projection system, larger amplitudes are equivalent to a higher optical resolution. Thus, laser projection based upon resonant operation of the MEMS scanner is widely adopted, because a favorable amplification of the micromirror oscillation amplitude can be exploited with low power consumption simultaneously. Unlike a raster scanning MEMS scanner, a Lissajous MEMS scanner operates at high scanning frequencies in both axes and offers simple fabrication, high mechanical stability, and uniform scanning quality.

The MEMS scanner frequently includes a micromirror, suspended by springs so as to be movable in one or more axes. When using the MEMS scanner for commercial purpose, one of the critical aspects to consider is the compactness. To achieve compactness, 2D MEMS micromirrors were proposed without a gimbal mount. It was proposed to implement 2D MEMS micromirrors by directly suspending the micromirror using the springs to a surrounding chip frame. However, the above architecture may still lead to inefficient use of the available chip space by suspensions. It is desirable that a deflection device for a scanner should contain smallest possible components while maintaining all requirements needed to achieve a good scanning resolution.

The inventors have recognized that there is a need to address the aforementioned technical drawbacks in existing technologies in providing a deflection device for Lissajous scanning.

### SUMMARY

It is an object of the present disclosure to provide a deflection device for Lissajous scanning with an optimized compact design for achieving a high scanning resolution. The compact design of the deflection device enables large tilt angles by means of long suspensions with less space utilization, thereby reducing the chip size.

This object is achieved by features of the independent claims. Further, the implementations forms are apparent from the dependent claims, the description, and the figures.

According to a first aspect, a deflection device for Lissajous scanning is provided. The deflection device includes a frame and a mirror. The mirror is movably arranged in a recess in the frame by means of a suspension mount including one or more springs. Each spring is connected at one end to the mirror and at the other end to the frame. Each spring has a shape of a path segment along a circumference of the mirror in such a way that path segment of all springs together covers more than 360 degrees. The arrangement of the one or more springs along the circumference of the mirror reduces the space needed for suspension of the mirror, and thus reduces the chip size.

The one or more springs may enable the mirror to swing back and forth about each of two or three axes with a respective eigenfrequency. The eigenfrequencies associated with the two or three axes may be equal or substantially equal. The mirror reflects a light beam at different angles to form a two-dimensional Lissajous pattern for providing high-quality images with high scan speed.

In a first possible implementation form of the deflection device, the deflection device includes a driving device that is configured to excite swing motion of the mirror about each of the two or three axes at or near the respective eigenfrequency. The driving device is configured to control a resonant operation of the mirror in the two or three axes.

The driving device may include one or more piezoelectric actuators. Each spring may be attached to one of the piezoelectric actuators. The one or more piezoelectric actuators are configured to displace the one or more springs with a high force when actuated with a low drive voltage.

The driving device may be configured to excite the swing motion by applying periodic driving signals to the one or more piezoelectric actuators. The periodic driving signals may include a driving signal for each of the two or three axes of the swing motion of the mirror. The driving signal may include a frequency that is equal or close to the eigenfrequency associated with the respective axis. The driving signal may convey energy to achieve the swing motion of the mirror about each of the two or three axes. The equal or substantially equal frequencies of the drive signal provide a high scanning curve fill factor that can support a high scanning display resolution.

In a second possible implementation form of the deflection device, the suspension mount includes two or more interlaced nested spiral springs. The two or more interlaced nested spiral springs may be a subset of the one or more springs. The two or more interlaced nested spiral springs reduce the space needed for suspension of the mirror.

The two or more interlaced nested spiral springs may be attached to the mirror at an equal angular distance. The two or more interlaced nested spiral springs attached to the mirror at the equal angular distance provide an improved fill factor of scanning trajectory and eliminates the need for a gimbal structure which is used in a gimbal-mounted mirror.

In a second possible implementation form of the deflection device, the suspension mount includes three interlaced nested spiral springs, attached to the mirror 120 degrees apart. Each interlaced nested spiral spring covers a circular segment of more than 120 degrees. Each of the three interlaced nested spiral springs has an increased length and a low-cross section area for providing a long suspension for the mirror. The long suspension helps to realize larger tilt angles without reaching a fracture limit of the three interlaced nested spiral springs.

In a third possible implementation form of the deflection device, the suspension mount includes four interlaced nested spiral springs, attached to the mirror 90 degrees apart. Each interlaced nested spiral spring covers a circular segment of more than 90 degrees. The increased number of interlaced nested spiral springs helps to compensate for the overall lower stiffness of each spiral spring, thus enabling a high scan frequency.

In a fourth possible implementation form of the deflection device, the two or more interlaced nested spiral springs are interlaced in an Archimedean spiral form around the mirror. The Archimedean spiral form provides a compact suspension mount for the mirror, thereby reducing the chip size.

A spring stiffness of at least one interlaced nested spiral spring may be different from a spring stiffness of the remaining interlaced nested spiral springs. The difference in the spring stiffness provides minimal differentiation between the resonance frequencies of the mirror.

At least one of a width, length, thickness and/or a material property of the at least one interlaced nested spiral spring may be different from that of the remaining interlaced nested spiral springs. Lowering the cross-sectional area and increasing the length of the interlaced nested spiral springs helps to realize larger tilt angles without reaching the fracture limit of the springs. In order to compensate for the overall lower stiffness of each spiral spring, a number of interlaced nested spiral springs may be increased up to the desired overall spring stiffness.

In a fifth possible implementation form of the deflection device, the two or more interlaced nested spiral springs are arranged in rotational or mirror symmetry in relation to the mirror. An arbitrary number of N springs are realized by rotating a next respective nested spiral spring by an angle of 2πN, where N is the number of springs. The two or more interlaced nested spiral springs may include a first spiral spring interlaced with the neighboring second or third or fourth or n-th spiral spring. The two or more interlaced nested spiral springs provide a densely packaged spiral spring arrangement, thereby enabling efficient use of the available chip space by the suspensions to achieve optimized compactness.

At least one interlaced nested spiral spring may be a torsion spring. The torsion spring provides an even tension, thus enabling repeatable vibration. The torsion spring has a shape of a path segment along a circumference of the mirror to minimize space requirements.

In a sixth possible implementation form of the deflection device, the mirror is configured such that the moment of inertia of the mirror is different in at least two axes for adjusting any difference between the frequencies of the driving signal associated with the respective axis.

A geometry of the mirror may be different with respect to the at least two axes. The geometry of the mirror may be selected so as to achieve tight packing of mirrors for reducing the chip size.

The mirror may be elliptical. The moment of inertia of the mirror may be modified by means of the elliptical mirror including one or more springs that are identically configured.

In a seventh possible implementation form of the deflection device, the driving device is configured to limit an amplitude of the swing motion of the mirror. The amplitude of the swing motion may be maintained within a resonance range of the mirror.

The driving device may include a control loop that is configured to control the frequencies of the periodic driving signals based upon a measured phase position of the mirror such that a maximum amplitude of the swing motion remains within the resonance range of the mirror. A level of the frequencies may be determined by a predefined scanning resolution and a predefined scanning repetition rate, and the periodic driving signals may have equal or different scanning repetition rates. The frequencies of the periodic driving signals continuously vary with respect to changes in resonance frequencies of the mirror. The frequencies of the periodic driving signals adapt perpetually to instantaneously occurring resonance frequencies of the mirror to result in a Lissajous trajectory to achieve a good image overlap.

In an eighth possible implementation form of the deflection device, the driving device further includes a drive electrode attached to each spring and/or to the mirror. The drive electrode is configured to displace the one or more springs with a high force when actuated with a low drive voltage.

The driving device may include one or more piezoelectric actuators connected to [e.g. arranged on] the one or more interlaced nested spiral springs. The one or more piezoelectric actuators may be arranged on the two or more interlaced nested spiral springs to obtain a compact configuration.

The mirror may be vacuum packaged. The vacuum-packed mirror provides low damping to achieve higher resonance amplitudes of the mirror. The vacuum-packed mirror provides greater achievable scanning angles, lower power consumption by several orders of magnitude, higher usable scanning frequencies, and lower drive voltages with electrostatic or piezoelectric actuators.

A technical problem in the prior art is resolved, where the technical problem is an inefficient use of a chip space for suspension of the mirror. Another technical problem in the prior art is resolved, where the technical problem is the lack of long suspensions with increased stiffness.

Therefore, compared with the prior art, the deflecting device for the Lissajous scanning provided in the present disclosure, has an optimized compact design for achieving a high scanning resolution. The compact design of the deflection device enables large tilt angles by means of long suspensions with less space utilization, thereby reducing the chip size.

These and other aspects of the present disclosure will be apparent from and the implementation(s) described below.

### BRIEF DESCRIPTION OF DRAWINGS

To illustrate the technical solutions in the implementations of the present disclosure or the prior art more clearly, the following briefly introduces the accompanying drawings required for describing the implementations of the prior art. Apparently, the accompanying drawings in the following description show merely some implementations of the present disclosure, and a person of ordinary skill in the art may still derive other drawings from these accompanying drawings without creative efforts.

FIG. 1 is a schematic diagram of a deflection device for Lissajous scanning in accordance with an implementation of the present disclosure;

FIG. 2 is a schematic diagram of a mirror of the deflection device of FIG. 1 that includes four springs attached to the mirror covering a circular segment of more than 90 degrees each in accordance with an implementation of the present disclosure;

FIG. 3 is a schematic diagram of the mirror of the deflection device of FIG. 1 that includes three springs attached to the mirror covering a circular segment of more than 120 degrees each in accordance with an implementation of the present disclosure; and

FIG. 4 is a schematic diagram of the mirror of the deflection device of FIG. 1 that includes four springs attached to the mirror covering a circular segment of more than 120 degrees each in accordance with an implementation of the present disclosure.

### DETAILED DESCRIPTION

Implementations of the present disclosure provide a deflection device for Lissajous scanning with an optimized compact design to enable large tilt angles by means of long suspensions while still enabling reduced space requirement and reduced chip size for achieving a high scanning resolution.

To make the solutions of the present disclosure more comprehensible for a person skilled in the art, the following clearly and completely describes the technical solutions in the implementations of the present disclosure with reference to the accompanying drawings in the implementations of the present disclosure. Apparently, the described implementations are merely a part rather than all of the implementations of the present disclosure. All other implementations obtained by a person of ordinary skill in the art based on the implementations of the present disclosure without creative efforts shall fall within the protection scope of the present disclosure.

In order to help understand implementations of the present disclosure, several terms that will be introduced in the description of the implementations of the present disclosure are defined herein first.

Terms such as “a first”. “a second”, “a third”, and “a fourth” (if any) in the summary, claims, and foregoing accompanying drawings of the present disclosure are used to distinguish between similar objects and are not necessarily used to describe a specific sequence or order. It should be understood that the terms so used are interchangeable under appropriate circumstances, so that the implementations of the present disclosure described herein are, for example, capable of being implemented in sequences other than the sequences illustrated or described herein. Furthermore, the terms “include” and “have” and any variations thereof, are intended to cover a non-exclusive inclusion. For example, a process, a method, a system, a product, or a device that includes a series of steps or units, is not necessarily limited to expressly listed steps or units, but may include other steps or units that are not expressly listed or that are inherent to such process, method, product, or device.

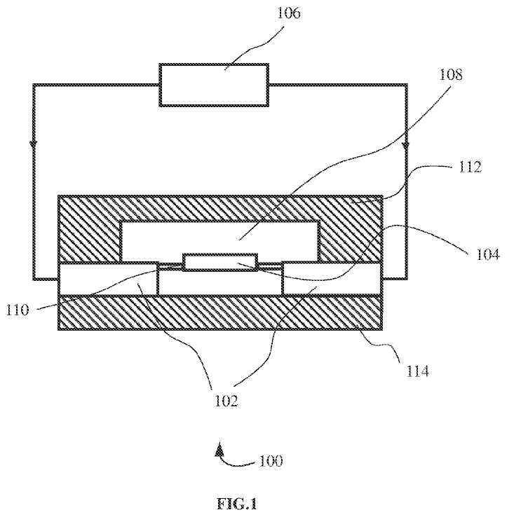

FIG. 1 is a schematic diagram of a deflection device 100 for Lissajous scanning in accordance with an implementation of the present disclosure. The deflection device 100 illustrated includes a frame 102, and a mirror 104. The mirror 104 is movably arranged in a recess in the frame 102 by means of a suspension mount including one or more springs 110. The frame 102 may be stationary and sealed by a first transparent surface 112 and a second transparent surface 114 respectively such that a vacuum-packed sealed chamber 108 is formed. The vacuum-packed sealed chamber 108 provides low damping to achieve higher resonance amplitudes of the mirror 104. Each of the one or more springs 110 is being connected at one end to the mirror 104 and at the other end to the frame 102. Each of the one or more springs 110 has a shape of a path segment along the circumference of the mirror 104 in such a way that the path segments of the one or more springs 110 together cover more than 360 degrees. The deflection device 100 may deflect a light beam from an incident axis.

The mirror 104 may be configured to swing back and forth about each of two or three axes with a respective eigenfrequency for reflecting incoming light at different angles. The eigenfrequency associated with the two or three axes is equal or substantially equal.

When the mirror 104 is irradiated with a light beam, the mirror 104 may reflect the light beam at different angles in two dimensions by the back and forth swing motion about each of two or three axes with the respective eigenfrequency to form a two-dimensional Lissajous pattern. The two-dimensional Lissajous pattern provides high-quality images with less power consumption and high scan speed compared to raster patterns.

The deflection device 100 includes a driving device 106 that is configured to excite swing motion of the mirror 104 about each of the two or three axes at or near the respective eigenfrequency. The driving device 106 may include one or more piezoelectric actuators. Each of the one or more springs 110 is attached to one of the one or more piezoelectric actuators. The driving device 106 may be configured to excite the swing motion by applying periodic driving signals to the one or more piezoelectric actuators attached to the one or more springs 110. In an example implementation, the one or more piezoelectric actuators act on the one or more springs 110 to excite the swing motion of the mirror 104 about each of the two or three axes at or near the respective eigenfrequency. The one or more piezoelectric actuators utilize low drive voltage thereby reducing power consumption by several orders of magnitude.

The periodic driving signals include for each of the two or three axes a driving signal. The driving signal may include a frequency equal or close to the eigenfrequency associated with a respective axis. The driving signal having a frequency equal or close to the eigenfrequency associated with a respective axis may differ at least in terms of a predefined scanning resolution and a predefined scanning repetition rate.

According to a first implementation of the deflection device 100, the driving device 106 further includes a drive electrode attached to each of the one or more springs 110 and/or to the mirror 104. The drive electrode may be an electrostatic drive unit, which is attached to the frame 102 at one end and to the each of the one or more springs 110 at the other end. The one or more springs 110 may be tightly arranged in a spiral shape around the mirror 104. The tight arrangement of the one or more springs 110 in a spiral shape around the mirror 104 reduces a chip space requirement for the suspension of the mirror 104 to a greater extent, thereby enabling an economical component by reducing the chip sire. The suspension mount may include two or more interlaced nested spiral springs. The two or more interlaced nested spiral springs may be a subset of the one or more springs 110. The two or more interlaced nested spiral springs may reduce the space needed for suspension. The two or more interlaced nested spiral springs may be attached to the mirror 104 at an equal angular distance.

According to a second implementation of the deflection device 100, the two or more interlaced nested spiral springs are arranged in rotational or mirror symmetry in relation to the mirror 104. An arbitrary number of N springs are realized by rotating a next respective nested spiral spring by an angle of 2πN, where N is the number of springs. The two or more interlaced nested spiral springs may be interlaced in an Archimedean spiral form around the mirror 104 to provide a compact suspension mount for the mirror 104. The Archimedean spiral form is a spiral form in which a radius increases linearly moving outward along the length of a spiral.

In an example implementation of the deflection device 100, four spiral springs of higher stiffness and wider cross-sectional area are arranged by rotating a next spring by 90 degrees relative to a preceding spiral spring. The four springs determine two orthogonal tilting eigenmodes of the mirror 104. In order to further increase the stiffness and scan speed of the mirror 104 at constant tilting axes, a fixed number of N additional springs of lower cross-sectional area may be implemented between the first four springs, respectively. The at least one of the width, the length, the thickness and/or the material property of the at least one of the interlaced nested spiral springs may be identical. The one or more piezoelectric actuators may be arranged on the two or more interlaced nested spiral springs with minimal inter-electrode distances so that to engage with each electrode efficiently.

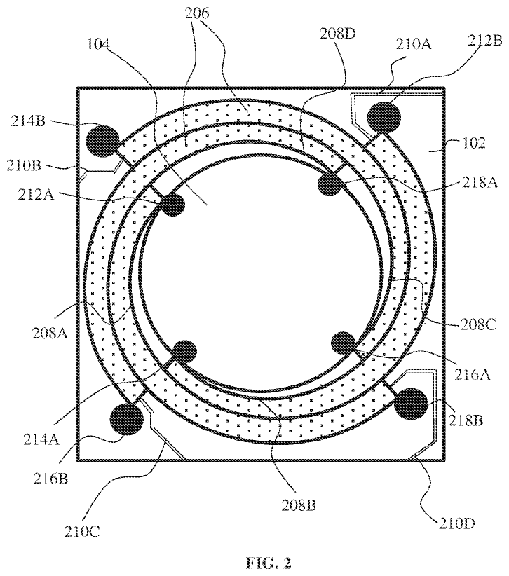

FIG. 2 is a schematic diagram of the mirror 104 of the deflection device 100 of FIG. 1 that includes four springs attached to the mirror 104 covering a circular segment of more than 90 degrees each in accordance with an implementation of the present disclosure. The mirror 104 includes a suspension mount 206 that includes a first spring 208A, a second spring 2083, a third spring 208C, and a fourth spring 208D. The first spring 208A includes a first end 212A and a second end 212B. The first spring 208A is attached to the mirror 104 with the first end 212A and to the frame 102 with the second end 212B. The second spring 208B includes a first end 214A and a second end 214B. The second spring 208B is attached to the mirror 104 with the first end 214A and to the frame 102 with the second end 214B. The third spring 208C includes a first end 216A and a second end 216B. The third spring 208C is attached to the mirror 104 with the first end 216A and to the frame 102 with the second end 216B. The fourth spring 208D includes a first end 218A and a second end 218B. The fourth spring 208D is attached to the mirror 104 with the first end 218A and to the frame 102 with the second end 218B. The first spring 208A, the second spring 208B, the third spring 208C and the fourth spring 208D may be attached to the mirror 104 at an equal angular distance of 90 degrees and each covers the circular segment of more than 90 degrees.

The first spring 208A, the second spring 208B, the third spring 208C and the fourth spring 208D may be interlaced in a form of a spiral around the mirror 104 resulting in an interlaced nested spiral spring structure around the mirror 104. The first spring 208A, the second spring 208B, the third spring 208C and the fourth spring 208D may be interlaced in the form of an Archimedean spiral around the mirror 104 to provide a compact suspension mount for the mirror 104. A stiffness of at least one of the first spring 208A, the second spring 208B, the third spring 208C or the fourth spring 208D may be different from the stiffness of remaining springs. The difference in the stiffness of the first spring 208A, the second spring 208B, the third spring 208C and/or the fourth spring 208D provides minimal differentiation between resonance frequencies of the mirror 104.

A width, length, thickness and/or a material property of at least one of the first spring 208A, the second spring 208B, the third spring 208C or the fourth spring 208D may be different from that of the remaining springs. Optionally, the length (l) of the first spring 208A, the second spring 208B, the third spring 208C and/or the fourth spring 208D is increased and a cross-sectional area of the first spring 208A, the second spring 208B, the third spring 208C and/or the fourth spring 208D is decreased. Lowering the cross-sectional area and increasing the length of the at least one of the first spring 208A, the second spring 208B, the third spring 208C or the fourth spring 208D helps to realize larger tilt angles without reaching a fracture limit of the first spring 208A, the second spring 2083, the third spring 208C or the fourth spring 208D.

In order to compensate for the overall lower stiffness of each of the first spring 208A, the second spring 2083, the third spring 208C and the fourth spring 208D, a number of springs may be increased up to a desired overall spring stiffness. The first spring 208A, the second spring 208B, the third spring 208C and the fourth spring 208D may be arranged in rotational or mirror symmetry in relation to the mirror 104. An arbitrary number of N springs may be realized by rotating a next respective nested spiral spring by an angle of 2πN, where N is the number of springs. The first spring 208A, the second spring 2083, the third spring 208C or the fourth spring 208D may be a torsion spring.

When the mirror 104 is irradiated with a light beam, the mirror 104 may be configured to swing back and forth about each of two or three axes with a respective eigenfrequency for reflecting incoming light at different angles to form a two-dimensional Lissajous pattern. The two-dimensional Lissajous pattern provides high-quality images with less power consumption and high scan speed compared to raster patterns. The eigenfrequency associated with the two or three axes may be equal or substantially equal. The driving device 106 may be configured to excite the swing motion of the mirror 104 about each of the two or three axes at or near the respective eigenfrequency by applying periodic driving signals to a first piezoelectric actuator 210A, a second piezoelectric actuator 210B, a third piezoelectric actuator 210C and a fourth piezoelectric actuator 210D attached to the first spring 208A, the second spring 2083, the third spring 208C and the fourth spring 208D respectively. The periodic driving signals may include for each of the two or three axes a driving signal having a frequency equal or close to the eigenfrequency associated with the respective axis.

The driving device 106 may be configured to limit an amplitude of the swing motion of the mirror 104. The amplitude of the swing motion may be maintained within a resonance range of the mirror 104. The mirror 104 may be configured such that the moment of inertia of the mirror 104 is different in at least two axes for adjusting any difference between the frequencies of the driving signal associated with the respective axis. A geometry of the mirror 104 may be different with respect to the at least two axes. The geometry of the mirror 104 may be determined by an optical beam size as well as the type of application, such as, projection or imaging. The mirror 104 may be elliptical with respect to the at least two axes. The moment of inertia may be modified by means of the elliptical mirror including the compact suspension mount with the first spring 208A, the second spring 2083, the third spring 208C and the fourth spring 208D that may be identically configured.

The first piezoelectric actuator 210A, the second piezoelectric actuator 2103, the third piezoelectric actuator 210C and the fourth piezoelectric actuator 210D may be arranged correspondingly on the first spring 208A, the second spring 208B, the third spring 208C and the fourth spring 208D arranged in the interlaced nested spiral spring structure to obtain a compact configuration.

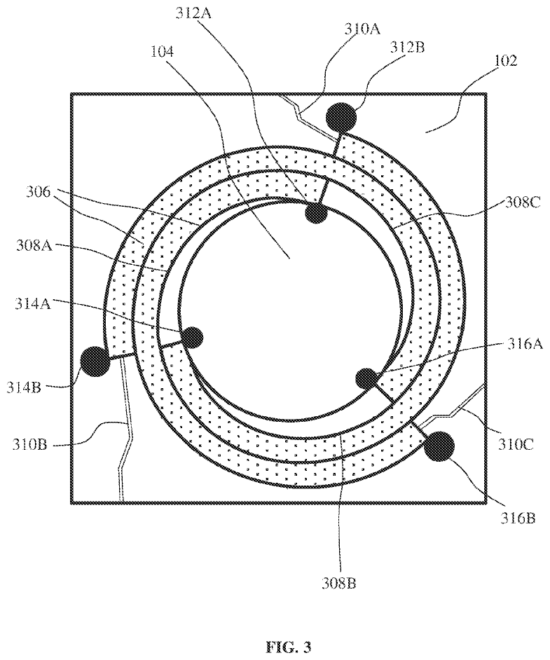

FIG. 3 is a schematic diagram of the mirror 104 of the deflection device 100 of FIG. 1 that includes three springs attached to the mirror 104 covering a circular segment of more than 120 degrees each in accordance with an implementation of the present disclosure. The mirror 104 includes a suspension mount 306 that includes a first spring 308A, a second spring 308B, and a third spring 308C. The first spring 308A includes a first end 312A and a second end 312B. The first spring 308A is attached to the mirror 104 with the first end 312A and to the frame 102 with the second end 312B. The second spring 308B includes a first end 314A and a second end 314B. The second spring 308B is attached to the mirror 104 with the first end 314A and to the frame 102 with the second end 314B. The third spring 308C includes a first end 316A and a second end 316B. The third spring 308C is attached to the mirror 104 with the first end 316A and to the frame 102 with the second end 316B. The first spring 308A, the second spring 308B, and the third spring 308C may be attached to the mirror 104 at an equal angular distance of 120 degrees and each covers the circular segment of more than 120 degrees.

The first spring 308A, the second spring 308B, and the third spring 308C may be interlaced in a form of a spiral around the mirror 104 resulting in an interlaced nested spiral spring structure around the mirror 104. The first spring 308A, the second spring 308B and the third spring 308C may be interlaced in the form of an Archimedean spiral around the mirror 104 to provide a compact suspension mount for the mirror 104. A stiffness of the first spring 308A, the second spring 308B and/or the third spring 308C may be different from the stiffness of remaining springs. The difference in the stiffness of the first spring 308A, the second spring 308B and/or the third spring 308C provides minimal differentiation between the resonance frequencies of the mirror 104.

A width, length, thickness and/or a material property of at least one of the first spring 308A, the second spring 308B or the third spring 308C may be different from that of the remaining springs. Optionally, the length (l) of the first spring 308A, the second spring 308B and/or the third spring 308C is increased and a cross-sectional area of the first spring 308A, the second spring 308B and/or the third spring 308C is decreased. Lowering the cross-sectional area and increasing the length of the at least one of the first spring 308A, the second spring 308B or the third spring 308C helps to realize larger tilt angles without reaching a fracture limit of the first spring 308A, the second spring 308B or the third spring 308C.

In order to compensate for the overall lower stiffness of each of the first spring 308A, the second spring 308B, and the third spring 308C, a number of springs may be increased up to a desired overall spring stiffness. The first spring 308A, the second spring 308B and the third spring 308C may be arranged in rotational or mirror symmetry in relation to the mirror 104. The first spring 308A, the second spring 308B or the third spring 308C may be a torsion spring.

When the mirror 104 is irradiated with a light beam, the mirror 104 may be configured to swing back and forth about each of two or three axes with a respective eigenfrequency for reflecting incoming light at different angles to form a two-dimensional Lissajous pattern. The two-dimensional Lissajous pattern provides high-quality images with less power consumption and high scan speed compared to raster patterns. The eigenfrequency associated with the two or three axes may be equal or substantially equal. The driving device 106 may be configured to excite the swing motion of the mirror 104 about each of the two or three axes at or near the respective eigenfrequency by applying periodic driving signals to a first piezoelectric actuator 310A, a second piezoelectric actuator 310B, and a third piezoelectric actuator 310C attached to the first spring 308A, the second spring 308B, and the third spring 308C respectively. The periodic driving signals may include for each of the two or three axes a driving signal having a frequency equal or close to the eigenfrequency associated with a respective axis.

The driving device 106 may be configured to limit an amplitude of the swing motion of the mirror 104. The amplitude of the swing motion may be maintained within a resonance range of the mirror 104. The mirror 104 may be configured such that the moment of inertia of the mirror 104 is different in at least two axes for adjusting any difference between the frequencies of the driving signal associated with the respective axis. A geometry of the mirror 104 may be different with respect to the at least two axes. The mirror 104 may be elliptical with respect to the at least two axes. The moment of inertia may be modified by means of the elliptical mirror including the suspension mount with the first spring 308A, the second spring 308B, and the third spring 308C that may be identically configured.

The first piezoelectric actuator 310A, the second piezoelectric actuator 310B, and the third piezoelectric actuator 310C may be arranged correspondingly on the first spring 308A, the second spring 308B, and the third spring 308C arranged in the interlaced nested spiral spring structure to obtain a compact configuration.

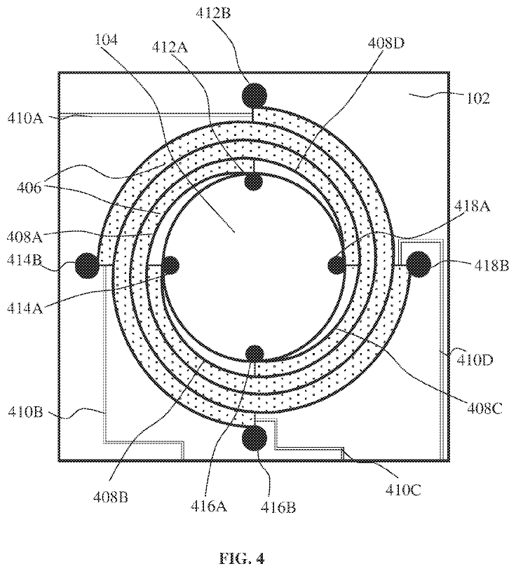

FIG. 4 is a schematic diagram of the mirror 104 of the deflection device 100 of FIG. 1 that includes four springs attached to the mirror 104 covering a circular segment of more than 90 degrees each in accordance with an implementation of the present disclosure. The mirror 104 includes a suspension mount 406 that includes a first spring 408A, a second spring 408B, a third spring 408C, and a fourth spring 408D. The first spring 408A includes a first end 412A and a second end 4123. The first spring 408A is attached to the mirror 104 with the first end 412A and to the frame 102 with the second end 412B. The second spring 408B includes a first end 414A and a second end 414B. The second spring 408B is attached to the mirror 104 with the first end 414A and to the frame 102 with the second end 414B. The third spring 408C includes a first end 416A and a second end 416B. The third spring 408C is attached to the mirror 104 with the first end 416A and to the frame 102 with the second end 416B. The fourth spring 408D includes a first end 418A and a second end 418B. The fourth spring 408D is attached to the mirror 104 with the first end 418A and to the frame 102 with the second end 418B. The first spring 408A, the second spring 408B, the third spring 408C, and the fourth spring 408D may be attached to the mirror 104 at an equal angular distance of 90 degrees and each covers the circular segment of more than 90 degrees.

The first spring 408A, the second spring 408B, the third spring 408C, and the fourth spring 408D may be interlaced in a form of a spiral around the mirror 104 resulting in an interlaced nested spiral spring structure around the mirror 104. The first spring 408A, the second spring 408B, the third spring 408C and the fourth spring 408D may be interlaced in the form of an Archimedean spiral around the mirror 104 to provide a compact suspension mount for the mirror 104.

When the mirror 104 is irradiated with a light beam, the mirror 104 is configured to swing back and forth about each of two or three axes with a respective eigenfrequency for reflecting incoming light at different angles to form a two-dimensional Lissajous pattern. The two-dimensional Lissajous pattern provides high-quality images with less power consumption and high scan speed compared to raster patterns. The eigenfrequency associated with the two or three axes is equal or substantially equal. The driving device 106 may be configured to excite the swing motion of the mirror 104 about each of the two or three axes at or near the respective eigenfrequency by applying periodic driving signals to a first piezoelectric actuator 410A, a second piezoelectric actuator 410B, a third piezoelectric actuator 410C, and a fourth piezoelectric actuator 410D attached to the first spring 408A, the second spring 408B, the third spring 408C, and the fourth spring 408D respectively. The periodic driving signals may include for each of the two or three axes a driving signal having a frequency equal or close to the eigenfrequency associated with a respective axis. The mirror 104 may be configured such that the moment of inertia of the mirror 104 is different in at least two axes for adjusting any difference between the frequencies of the driving signal associated with the respective axis.

The first piezoelectric actuator 410A, the second piezoelectric actuator 410B, the third piezoelectric actuator 410C, and the fourth piezoelectric actuator 410D may be arranged correspondingly on the first spring 408A, the second spring 408B, the third spring 408C and the fourth spring 408D arranged in the interlaced nested spiral spring structure to obtain a compact configuration.

The mirror 104 may be a MEMS (Micro-Electrical-Mechanical-System) mirror. The mirror 104 may be a micromirror including a diameter ranging from 0.5 millimeter (mm) to 10 mm. The mirror 104 may include a flat reflective surface and may be coated with a thin film of reflective material such as gold, aluminium or silver to obtain strong light reflection in the visible and Infra-Red wavelength. The mirror 104 may reflect an electromagnetic wave radiated from a light source while changing an angle of a reflection surface thereof. The movement of the mirror 104 is optionally a superposition of two or three independent swing motion (e.g. one per axis). This decomposition of the independent swing motion is probably possible only for relatively small amplitudes (e.g. not more than a few degrees of rotations for each axis). The mirror 104 may be excited by electromagnetic forces in a moving coil arrangement. The mirror 104 may be excited by the electromagnetic forces in a moving magnet arrangement.

The first transparent surface 112 and the second transparent surface 114 encapsulating the mirror 104 may be made up of a transparent material as the incoming light can either come from one side or from two sides of the surfaces of the mirror 104.

In an example, when the mirror 104 with a high-quality is used, for example, having a quality factor of greater than 3,000, the amplitude response thereof has a strong resonance increase, and a corresponding phase response has a strong decrease. Therefore, the mirror 104 with the high-quality undergoes very substantial changes to its amplitude, even with small resonance frequency-shifts such that, small temperature changes, for example, are sufficient for bringing the mirror 104 out of resonance. In that case, the driving signal with a fixed frequency would no longer produce an acceleration effect, and would instead produce a deceleration effect. Hence, the driving device 106 may include a control loop for controlling the frequencies of the periodic driving signals. The periodic drive signals depend on the measured phase position of the mirror 104, such that the phase and the maximum amplitudes of the swing motion are held within the resonance range of the mirror 104. The phase and the amplitude of the swing motion may be held constant by the control loop. Optionally, two phase control loops that are independent of one another are provided. The frequencies of the periodic driving signals, therefore, are not fixed, but are continuously variable. They react to all shifts in resonance frequencies of the mirror 104 that occur. The frequencies (i.e. repetition rates) of the periodic driving signals changes actively in a close-loop control. Frequency values of the periodic signals are almost equal and have a frequency difference from about 30 hertz (Hz) to 120 Hz according to a refresh rate of a scanning display. The frequency difference is a small frequency value compared with typical driving frequencies which ranges from several kHz to 100 kHz. The perpetual adaptation of the frequencies of the driving signals to the instantaneously occurring resonance frequencies of the mirror 104 results in a Lissajous trajectory that is traveling, whereby all areas on a projection screen are described with image data to achieve a good image overlap. A temperature-induced phase control may be possible with mirrors of lower quality, e.g. greater than 300.

In an example implementation, the predefined scanning resolution and the predefined scanning repetition rate for the allowable modification range for amplitude may be determined based on properties of the mirror 104 and the resolution of the viewing field. For example, the modification range is predefined as an inverse value of a minimum resolution in an axis. With a definition using pixels, the amplitude may change by less than one-pixel width. For example, in the case of a minimal resolution of 480×640 pixels, the amplitude of the mirror 104 may change by less than 1/480 (0.00283) and 1/640 (0.00146). The amplitude may change by at least one of less than 1%, less than 0.5%, or less than 0.3%. The diving signal having a frequency equal to the eigenfrequency associated with the respective axis may lead to a circular scanning or elliptical scanning. To cover the full projection area an amplitude modulation may be needed that continuously changes a diameter of a circle or a diameter of an ellipse.

In an example implementation, each interlaced nested spiral spring is described in polar coordinates by

r(θ)=a+b·θ

with r is a radius, a is an initial radius, b=a measure of growth of the radius, θ=an angle θ·n·2·ω, n=a number of turns of the interlaced nested spiral spring.

In cartesian coordinates, the interlaced nested spiral spring may be designed and described by:

x_{component}=r·cos(θ)=(a+b·θ)·cos(θ)

v_{component}=r·sin(0)=(a+b·0)·sin(0)

The growth factor (b) may be described by a ratio of the difference of final radius a_{final} and the initial radius aᵢₙᵢₜᵢₐₗ divided by the desired number of turns n:

b=(a_{final}−aᵢₙᵢₜᵢₐₗ)/(2·π·n)

The two or more interlaced nested spiral springs including a first spiral spring interlaced with the neighboring second or third or fourth or n-th spiral spring provide a densely packaged spiral spring arrangement enabling efficient use of the available chip space by the suspensions to achieve optimized compactness.

Although the present disclosure and its advantages have been described in detail, it should be understood that various changes, substitutions and alterations can be made herein without departing from the spirit and scope of the disclosure as defined by the appended claims.

1. A deflection device for Lissajous scanning, comprising a frame and a mirror,
the mirror being movably arranged in a recess in the frame by means of a suspension mount comprising one or more springs, each spring being connected at one end to the mirror and at the other end to the frame, wherein each of the one or more springs has a shape of a path segment along a circumference of the mirror in such a way that the path segments of the one or more springs together cover more than 360 degrees.

2. The deflection device according to claim 1, wherein the one or more springs enable the mirror to swing back and forth about each of two or three axes with a respective eigenfrequency, the eigenfrequencies associated with the two or three axes being equal or substantially equal.

3. The deflection device according to claim 2, wherein the deflection device comprises a driving device that is configured to excite swing motion of the mirror about each of the two or three axes at or near the respective eigenfrequency.

4. The deflection device according to claim 3, wherein the driving device comprises one or more piezoelectric actuators, each of the one or more springs, being attached to one of the one or more piezoelectric actuators.

5. The deflection device according to claim 4, wherein the driving device is configured to excite the swing motion by applying periodic driving signals to the one or more piezoelectric actuators, the periodic driving signals including for each of the two or three axes a driving signal having a frequency equal or close to the eigenfrequency associated with the respective axis.

6. The deflection device according to claim 1, wherein the suspension mount comprises two or more interlaced nested spiral springs, wherein the two or more interlaced nested spiral springs is a subset of the one or more springs.

7. The deflection device according to claim 6, wherein the two or more interlaced nested spiral springs are attached to the mirror at equal angular distance.

8. The deflection device according to claim 7, wherein the suspension mount comprises
three interlaced nested spiral springs, attached to the mirror 120 degrees apart and each covering a circular segment of more than 120 degrees, or
four interlaced nested spiral springs, attached to the mirror 90 degrees apart and each covering a circular segment of more than 90 degrees.

9. (canceled)

10. The deflection device according to claim 6, wherein the two or more interlaced nested spiral springs are arranged in at least one of the following ways:
interlaced in the form of an Archimedean spiral around the mirror,
arranged in rotational or mirror symmetry in relation to the mirror.

11. The deflection device according to claim 6, wherein a spring stiffness of at least one of the two or more interlaced nested spiral springs is different from a spring stiffness of the remaining interlaced nested spiral springs.

12. The deflection device according to claim 6, wherein at least one of a width, length, thickness and/or material property of the at least one of the two or more interlaced nested spiral springs is different from that of the remaining interlaced nested spiral springs.

13. (canceled)

14. The deflection device according to claim 1, wherein at least one of the two or more interlaced nested spiral spring is a torsion spring.

15. The deflection device according to claim 1, wherein the mirror is configured such that the moment of inertia of the mirror is different in the at least two axes for adjusting any difference between the frequencies of the driving signal associated with the respective axis.

16. The deflection device according to claim 15, wherein a geometry of the mirror is different with respect to the at least two axes.

17. The deflection device according claim 16, wherein the mirror is elliptical.

18. The deflection device according to claim 5, wherein the driving device is configured to limit an amplitude of the swing motion.

19. The deflection device according to claim 18, wherein the driving device comprises a control loop configured to control the frequencies of the periodic driving signals based upon a measured phase position of mirror, wherein a level of the frequencies is determined by a predefined scanning resolution and a predefined scanning repetition rate, and wherein the periodic driving signals have equal or different scanning repetition rates.

20. The deflection device of claim 3, wherein the driving device further comprises a drive electrode attached to each of the one or more springs and/or to the mirror.

21. The deflection device of claim 20, wherein the driving device comprises one or more piezoelectric actuators connected to or arranged on the one or more interlaced nested spiral springs.

22. The deflection device of claim 1, wherein the mirror is vacuum packaged.
